(19) United States
(12) Patent Application Publication
(10) Pub. No.: US 2016/0318451 A1
(43) Pub. Date: Nov. 3, 2016

(54) DETACHABLE/RESIZABLE TRUNK ORGANIZER

(71) Applicant: FORD GLOBAL TECHNOLOGIES, LLC, Dearborn, MI (US)

(72) Inventor: Ningna Li, Novi, MI (US)

(21) Appl. No.: 14/699,082

(22) Filed: Apr. 29, 2015

(51) Int. Cl. B60R 7/02

(52) U.S. Cl. CPC B60R 7/02

(57) ABSTRACT

A vehicle trunk organizer assembly includes one or more tracks or track receivers associated with a vehicle trunk floor and an organizer unit including one or more tracks or track receivers. The one or more tracks are configured to be slidably received in the one or more track receivers. The organizer unit is defined by at least a side wall and a floor including the one or more tracks or track receivers disposed on a bottom surface thereof. The one or more tracks or track receivers may be inset into the vehicle trunk floor. The organizer unit side wall is configured with a plurality of brackets for receiving and holding one or more removable separators. Vehicle trunk assemblies and vehicles including the vehicle trunk organizer assembly and or the vehicle trunk assembly are described.

### TECHNICAL FIELD

This disclosure relates generally to organizers for motor vehicle. More particularly, the disclosure relates to an improved motor vehicle trunk organizer.

### BACKGROUND

Typically, motorists use the trunk compartment of a vehicle as a catch-all for items, simply tossing the items into the trunk and retrieving them as necessary. However, loose items can slide about in a trunk, resulting in damage to the items or at least annoying and distracting noise. Moreover, when a large number of items are contained in the trunk, it can be difficult to find and retrieve a specific item. For this reason, a variety of organizers of different configurations and sizes are known for use in a vehicle trunk, varying from structures as simple as a cardboard box to more complex, specially designed organizers.

A disadvantage of even well-designed organizers for use in vehicle trunks is that they are often simply placed in the trunk without restraint, and may slide, slip, or tip over and discharge their contents into the trunk during normal vehicle maneuvers such as turns, abrupt stops, etc. It is possible and known to secure items such as organizers in a vehicle trunk, such as by cordage, cargo nets, bungee cords, etc., but that is inconvenient for the user. It would likewise be possible to provide a dedicated attachment (bolts, screws, etc.) of an organizer to, e.g., a trunk floor or side wall, but that would eliminate the space occupied by the organizer from alternative uses and would be inconvenient to remove. In turn, it would be a convenience to the user to have a trunk-mounted organizer that could be easily moved in a predefined manner for loading/unloading and then returned to a stowed position within the trunk, but that could also be removed from the trunk space completely when needed.

To solve these and other problems, the present disclosure relates to a vehicle trunk organizer assembly. Advantageously, the organizer provides a convenient, adaptable, and reconfigurable storage compartment which can be slidably received in the vehicle trunk, thus preventing undesired sliding or tipping of the organizer during sudden turns, stops, etc., with potential loss of contents.

### SUMMARY

In accordance with the purposes and benefits described herein, in one aspect a vehicle trunk organizer assembly is provided, including one or more track receivers associated with a vehicle trunk floor. The track receivers may be inset into the vehicle trunk floor. An organizer unit is provided including tracks configured to be slidably received in the one or more track receivers. Alternatively, the track receivers may be associated with the vehicle trunk organizer and the tracks may be disposed on or in the vehicle trunk floor. The organizer unit may include a plurality of brackets for receiving and holding one or more removable separators defining interior dividers and/or shelves.

In another aspect, a vehicle trunk assembly including the vehicle trunk organizer assembly is described.

In the following description, there are shown and described embodiments of the disclosed vehicle trunk organizer assembly. As it should be realized, the device is capable of other, different embodiments and its several details are capable of modification in various, obvious aspects all without departing from the devices and methods as set forth and described in the following claims. Accordingly, the drawings and descriptions should be regarded as illustrative in nature and not as restrictive.

### BRIEF DESCRIPTION OF THE DRAWINGS

The accompanying drawing figures incorporated herein and forming a part of the specification, illustrate several aspects of the disclosed vehicle trunk organizer assembly, and together with the description serve to explain certain principles thereof. In the drawing:

FIG. 1A depicts a vehicle trunk compartment including a trunk organizer unit assembly according to the present disclosure;

FIG. 1B depicts an alternative embodiment of the assembly of FIG. 1A;

FIG. 2 shows a bottom view of an organizer unit according to the present disclosure;

FIG. 3A depicts an interior of an embodiment of the organizer unit of FIG. 2, showing brackets for receiving removable dividers and/or shelves;

FIG. 3B depicts an interior of an alternative embodiment of the organizer unit of FIG. 2, showing slots for receiving removable dividers and/or shelves;

FIG. 4 shows a pair of removable dividers received in the brackets of the organizer unit of FIG. 3; and

FIG. 5 shows a removable shelf received in the brackets of the organizer unit of FIG. 3.

Reference will now be made in detail to embodiments of the disclosed vehicle trunk organizer assembly, examples of which are illustrated in the accompanying drawing figures.

### DETAILED DESCRIPTION

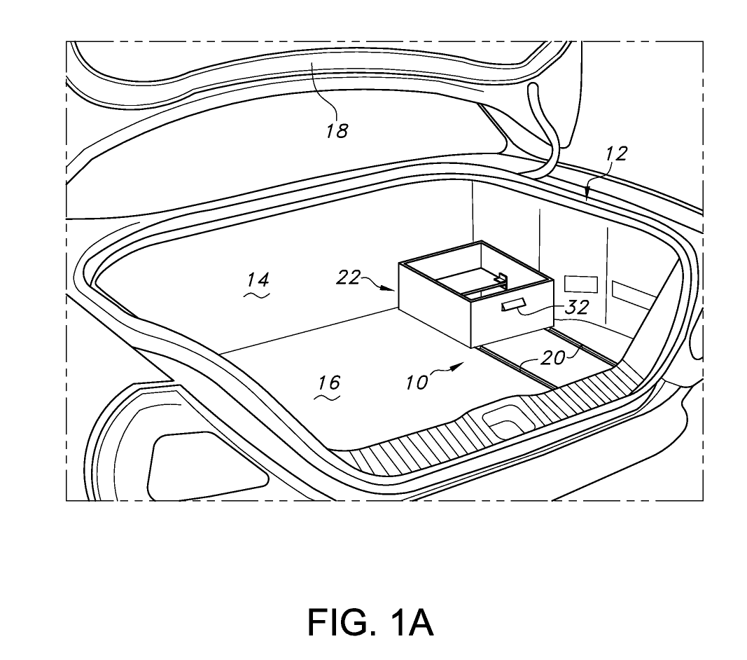

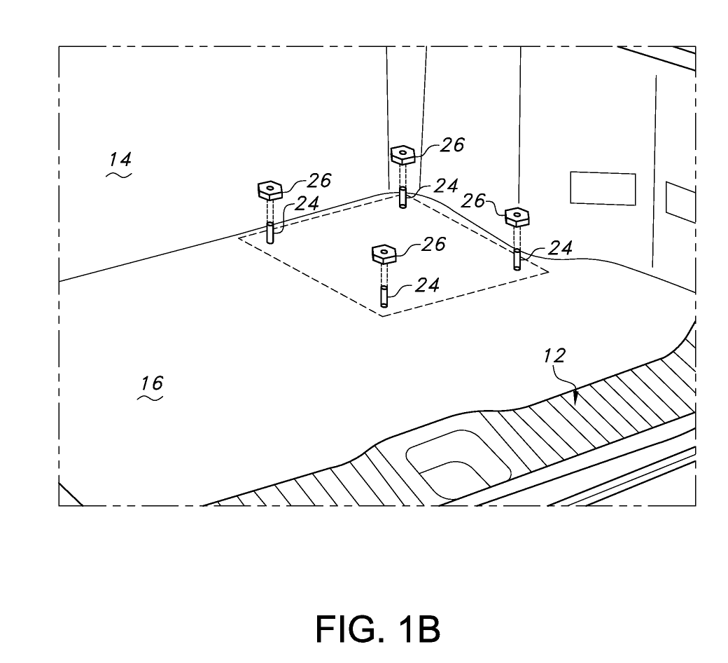

To address the issues described above, the present disclosure provides a vehicle trunk organizer unit assembly 10. With reference to FIG. 1A, a vehicle V trunk 12 provides, as is well known in the art, a storage compartment defined by at least one side wall 14 and a floor 16. A hinged lid 18 is included to protect items stored within the trunk 12 from theft, weather, etc.

In the depicted embodiment, trunk floor 16 includes one or more track receivers 20. In the embodiment depicted in FIG. 1A a pair of parallel track receivers 20 are provided. However, the skilled artisan will readily realize that one, two, three, or more track receivers 20 may be provided in accordance with the dimensions of an organizer unit 22 (discussed in greater detail below) to be received therein.

Likewise, the skilled artisan will readily appreciate that track receivers 20 may be oriented in any desired direction relative to an x-y axis of the vehicle V and in accordance with the specific region of the trunk 12 in which the organizer unit 22 is to be held. As shown, track receivers 20 are positioned whereby an organizer unit 22 received therein is positioned in a right rear corner of trunk 12, thus maximizing the remaining space available in trunk 12 for other items. In the depicted embodiment, track receivers 20 are inset into the floor 16 of trunk 12, thus avoiding creating any ridges or other obstacles in the trunk floor 16 that might impede convenient loading of other items into the trunk 12.

An alternative embodiment of the organizer unit assembly 10 is partially depicted in FIG. 1B. As shown, one or more threaded pins 24 may be provided in floor 16, to be received by cooperating apertures (not shown in this view) in the organizer unit 22. In use, the organizer unit 22 is secured to the trunk floor 16, such as by nuts 26. Of course, in yet another alternative embodiment (not shown), threaded apertures may be provided in trunk floor 16, and the organizer unit 22 could then simply be secured to the floor 16 by threaded bolts or screws passing through the organizer unit 22 cooperating apertures and into the threaded apertures.

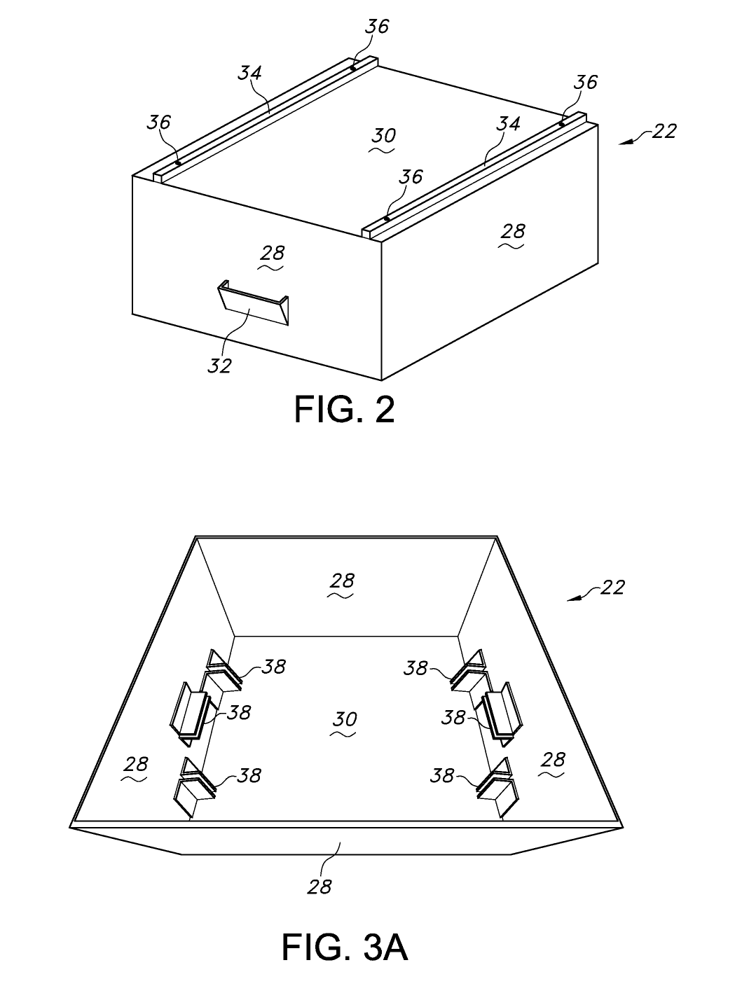

Turning to FIG. 2, a bottom view of an organizer unit 22 is provided. In the depicted embodiment, the organizer unit 22 is a substantially rectangular box defined by at least one side wall 28 and a floor 30. One or more carrying handles 32 may be included for convenience in handling the organizer unit 22. One or more tracks 34 are associated with a bottom surface of the floor 30, in the depicted embodiment being secured to floor 30 by bolts or screws 36 passing through cooperating apertures (not visible in this view) in floor 30. It is these apertures that are used in the alternative embodiment of the organizer unit assembly 10 described above.

In use, tracks 34 are slidably received in track receivers 20 (see FIG. 1A). As will be appreciated, the organizer unit 22 can be translated forwardly to a front area of trunk 12 by way of cooperating tracks 34/track receivers 20, for example to load items into or retrieve items from the organizer unit. Once the items have been loaded or unloaded as desired, the organizer unit 22 can then be translated back to the rear area of the trunk 12 where it will be out of the way.

A number of suitable configurations of tracks 34 and track receivers 20 are possible and contemplated for use herein. In the depicted embodiment, the track receivers 20 are u-shaped receivers or channels configured to slidably receive tracks 34 in an interior thereof. Alternatively, track receivers 20 may be configured as sleeves including bearings or rollers to ensure smooth sliding of tracks 34. In yet another alternative, rollers, bearings, or wheels may be associated with tracks 34. Still more, one or more stops, detents, and/or hold-in mechanisms and releases therefor (not shown) may be included to retain the organizer unit 22 in a desired position and/or to prevent inadvertent sliding in or removal of the organizer unit 22 from track receivers 20. Such mechanisms are well known to the skilled artisan, for example in the cabinetry and/or drawer slide arts, and require no further description herein.

In turn, other mechanical means may be used to retain the organizer unit 22 in a desired position and/or to prevent inadvertent sliding of the organizer unit 22. As non-limiting examples, elastic straps could be used to anchor the unit 22 to a desired portion of the trunk floor 30, for example elastic straps secured at the ends thereof to tracks 34 and/or to brackets (not shown) disposed in the trunk 12. As yet another alternative, tracks 34 may include transverse slots (not shown) disposed along a longitudinal dimension thereof, and configured for receiving one or more stops therein to prevent movement of unit 22.

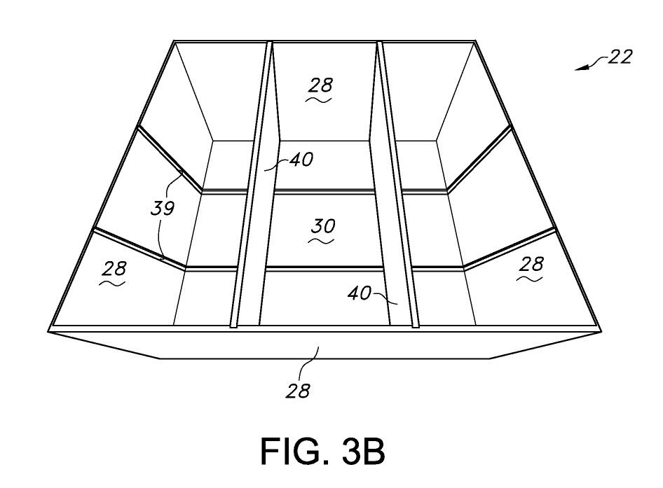

Retaining structures are provided for slidably receiving and holding one or more removable separators in an interior of organizer unit 22. As shown in FIG. 3A, in one embodiment one or more brackets 38 are included in an interior of the organizer unit 22, for slidably receiving and holding one or more removable separators such as dividers 40 and/or shelves 42 (not shown in this view) in an interior of the organizer unit 22. In the depicted embodiment each bracket 38 is provided by two opposed, aligned L-brackets defining a slot therebetween. However, it will be appreciated than any number of bracket configurations are suitable, and therefore are contemplated for use herein.

In another embodiment, as shown in FIG. 3B, a plurality of slots 39 may be provided on or in side walls 28/floor 30 of the organizer unit 22 for slidably receiving and holding one or more removable separators 40. Likewise, additional slots 39 (not shown in this view for clarity) may be provided for slidably receiving one or more shelves 42 at desired positions within the organizer unit 22.

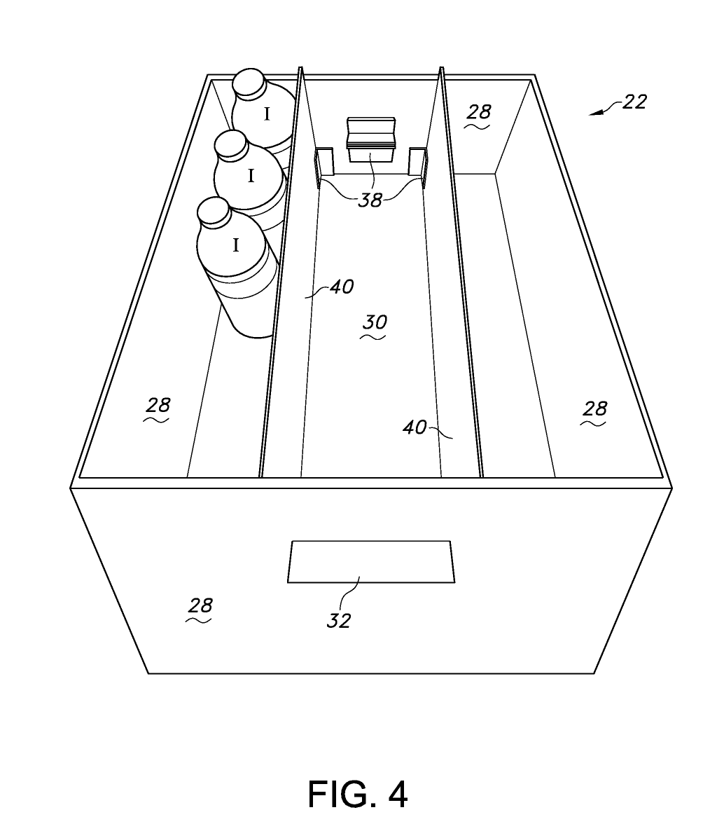

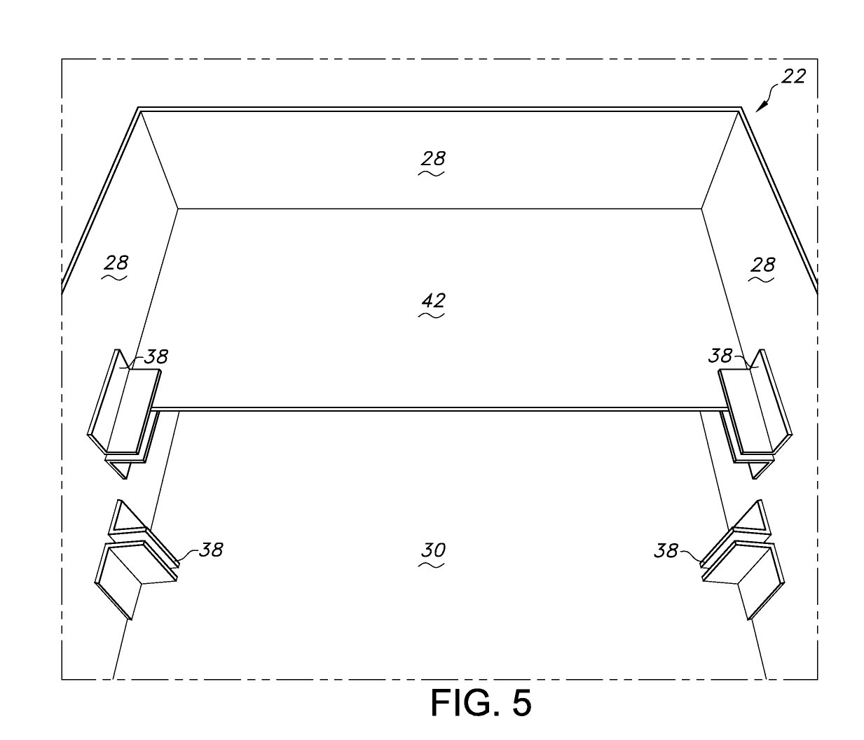

As shown in FIG. 4, a user need only slide in one or more separators, for example dividers 40 or shelves 42 (see FIG. 5) to provide a plurality of convenient spaces for organizing various items I in the organizer unit 22. Of course, brackets 38 may be replaced or supplemented with one or more slots 39 as shown in FIG. 3B, to receive dividers 40 and/or shelves 42 in desired locations of the interior of organizer unit 22. As is readily appreciated, in the depicted embodiment removable dividers 40 are used to separate the organizer unit 22 into three storage areas for storage of items. In turn, by adding one or more shelves 42 (see FIG. 5) a split level organizer unit 22 is provided.

Thus, by use of the presently disclosed organizer unit assembly 10, a convenient, reconfigurable storage organizer is provided for use in a vehicle trunk 12, which slides into/out from a desired position in the trunk for loading and unloading. Obvious modifications and variations are possible in light of the above teachings. For example, in an alternative embodiment (not shown) track receivers 20 are disposed on the bottom surface of the floor 30, and tracks 34 are disposed on or inset into trunk floor 16. As another example, an optional lid (not shown) may be provided for organizer unit 22, including a lid that is hinged, sliding, or otherwise. When the lid is provided, the organizer 22 may include a closure or catch for the lid to prevent inadvertent opening.

As will be readily appreciated, the organizer unit 22 may be dimensioned as desired (with the caveat that it fits within an interior of trunk 12) in accordance with the dimensions of items which will or may be placed therein. Still more, the organizer unit 22 may be made stackable to allow stacking a plurality of like organizer units 22 thereupon. Still yet more, the organizer unit 22 may be fabricated of any number of suitable materials, including without intending any limitation suitably durable plastics, polymers, metals, metal or polymer meshes, and combinations thereof in accordance with requirements for durability, weight, content visibility, etc. All such modifications and variations are within the scope of the appended claims when interpreted in accordance with the breadth to which they are fairly, legally and equitably entitled.

What is claimed:

1. A vehicle trunk organizer assembly, comprising:
one or more tracks or track receivers associated with a vehicle trunk floor; and
an organizer unit including one or more tracks or track receivers;
the one or more tracks being configured to be slidably received in the one or more track receivers.

2. The trunk organizer assembly of claim 1, wherein the organizer unit is defined by at least a side wall and a floor including the one or more tracks or track receivers disposed on a bottom surface thereof.

3. The trunk organizer assembly of claim 1, wherein the one or more tracks or track receivers are inset into the vehicle trunk floor.

4. The trunk organizer assembly of claim 2, wherein the side wall is configured with a plurality of brackets for receiving and holding one or more removable separators.

5. The trunk organizer assembly of claim 4, wherein the organizer unit floor is further configured to attach directly to the vehicle trunk floor.

6. A vehicle including the trunk organizer assembly of claim 1.

7. A vehicle trunk assembly, comprising:
a vehicle trunk compartment comprising a side wall, a closable lid, and a floor including one or more tracks or track receivers; and
an organizer unit including one or more tracks or track receivers;
the one or more tracks being configured to be slidably received in the one or more track receivers.

8. The trunk assembly of claim 7, wherein the organizer unit is defined by at least a side wall and a floor including the one or more tracks or track receivers disposed on a bottom surface thereof.

9. The trunk assembly of claim 7, wherein the one or more tracks or track receivers are inset into the vehicle trunk floor.

10. The trunk assembly of claim 8, wherein the side wall is configured with a plurality of brackets for receiving and holding one or more removable separators.

11. The trunk assembly of claim 10, wherein the organizer unit floor is configured to attach directly to the vehicle trunk floor.

12. A vehicle including the trunk assembly of claim 7.

13. A vehicle trunk organizer assembly, comprising:
one or more tracks or track receivers associated with a vehicle trunk floor; and
an organizer unit defined by at least a side wall and a floor including one or more tracks or track receivers;
the one or more tracks being configured to be slidably received in the one or more track receivers.

14. The trunk organizer assembly of claim 13, wherein the one or more tracks or track receivers are inset into the vehicle trunk floor.

15. The trunk organizer assembly of claim 14, wherein the side wall is configured with a plurality of brackets for receiving and holding one or more removable separators.

16. A vehicle including the trunk organizer assembly of claim 13.
